(19) United States
(12) Patent Application Publication
(10) Pub. No.: US 2024/0202543 A1
(43) Pub. Date: Jun. 20, 2024

(54) COMPRESSION OF MODEL WEIGHTS FOR DISTRIBUTED AND FEDERATED LEARNING

(71) Applicant: VMware LLC, Palo Alto, CA (US)

(72) Inventors: Yaniv Ben-Itzhak, Herzliya (IL); Shay Vargaftik, Herzliya (IL); Ron Dorfman, Haifa (IL)

(21) Appl. No.: 18/067,503

(22) Filed: Dec. 16, 2022

(51) Int. Cl. G06N 3/098

(52) U.S. Cl. CPC G06N 3/098

(57) ABSTRACT

Techniques for compressing the model weights of an artificial neural network (ANN) in the context of distributed learning (DL) or federated learning (FL) are provided. In one set of embodiments, these techniques include a hybrid approach for compressing the model weights that employs (1) a high complexity compression scheme to compress the ANN's model weights every k rounds of the DL/FL procedure (referred to as anchor rounds), and (2) a low complexity compression scheme to compress accumulated differences in model weights of the ANN for intermediate rounds between the anchor rounds.

### BACKGROUND

Unless specifically indicated herein, the approaches described in this section should not be construed as prior art to the claims of the present application and are not admitted to be prior art by inclusion in this section.

Distributed learning (DL) and federated learning (FL) are machine learning techniques that allow multiple computing devices/systems, referred to as clients, to collaboratively train an artificial neural network (ANN) under the direction of a central server, referred to as a parameter server. The main distinction between these two techniques is that the training dataset used by each FL client is private to that client and thus inaccessible by other FL clients. For example, each FL client may be a mobile device that is owned and operated by a different individual. In DL, the clients are typically owned/operated by a single entity (e.g., an enterprise) and thus may have access to some or all of the same training data.

Both DL and FL proceed over a series of rounds, where each round includes (1) transmitting, by the parameter server, a vector of the ANN's model weights (referred to as a model weight vector) to a participating subset of the clients; (2) executing, by each participating client, a training pass on the ANN, the training pass resulting in computation of a vector of derivatives of a loss function with respect to the model weights (referred to as a gradient); (3) transmitting, by each participating client, its computed gradient to the parameter server; (4) averaging, by the parameter server, the gradients received from the clients to produce a global gradient; and (5) using, by the parameter server, the global gradient to update the model weights of the ANN. The sizes of the model weight vector and the gradients transmitted at steps (1) and (3) are proportional to the number of parameters in the ANN, which can be very high (e.g., on the order of billions). Thus, DL/FL is often bottlenecked by the amount network bandwidth available between the parameter server and the clients, particularly in scenarios where the clients are devices with limited and/or unstable network connectivity (e.g., mobile devices, IoT (Internet of Things) devices, etc.).

Existing approaches that attempt to solve this problem via data compression generally focus on compressing the gradients sent by the clients using a compression scheme with relatively low encoding complexity and thus relatively high encoding speed, which is important for a real-time solution. However, low encoding complexity compression schemes also introduce higher levels of approximation error in their compressed outputs, which makes it challenging to use such schemes for compressing the model weight vector sent by the parameter server, for several reasons.

First, as mentioned above, the gradients are received by the parameter server from multiple clients in each round and then averaged together to produce the global gradient. As a result, the approximation error introduced into the global gradient by compressing each individual gradient is inversely proportional to the number of participating clients (assuming the approximation errors in the individual compressed gradients are independent and unbiased) and thus will typically be small. In contrast, the model weight vector is received by the participating clients from a single entity (i.e., the parameter server). Accordingly, there is no averaging process that reduces the approximation error arising out of compressing this vector.

Second, the norms (i.e., lengths) of the gradients decay to zero as the DL/FL procedure progresses because they indicate how “far off” the ANN is from an optimized state and therefore they diminish as the ANN converges. This means that the approximation errors in the compressed versions of these gradients also decay to zero. In contrast, the norm of the model weight vector is an arbitrary value that does not decay as the DL/FL procedure progresses. Thus, the approximation error introduced by compressing this vector remains relatively constant throughout the DL/FL procedure, which can potentially delay or prevent convergence.

### BRIEF DESCRIPTION OF THE DRAWINGS

FIG. 1 depicts an example DL/FL system.

FIG. 2 depicts a workflow of a conventional DL/FL procedure.

FIG. 3 depicts an example ANN.

FIG. 4 depicts a workflow for compressing model weights in the context of a DL/FL procedure according to certain embodiments.

FIG. 5 depicts a workflow for increasing the time window provided to clients for downloading model weights according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Conventional DL/FL and Solution Overview

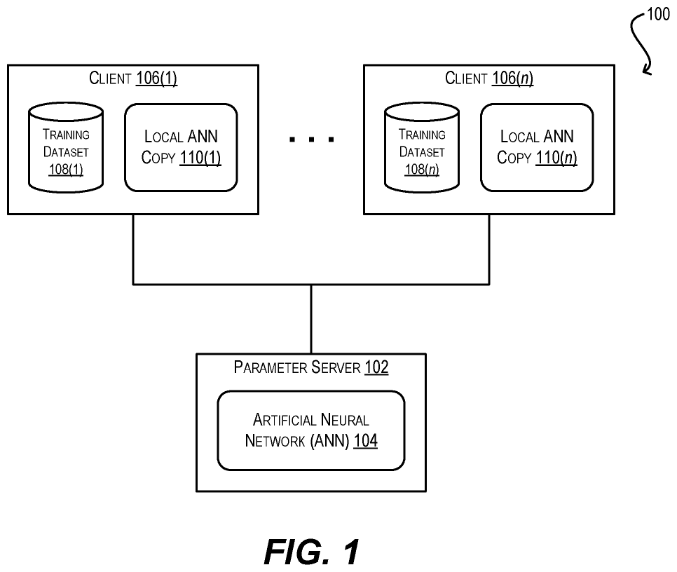

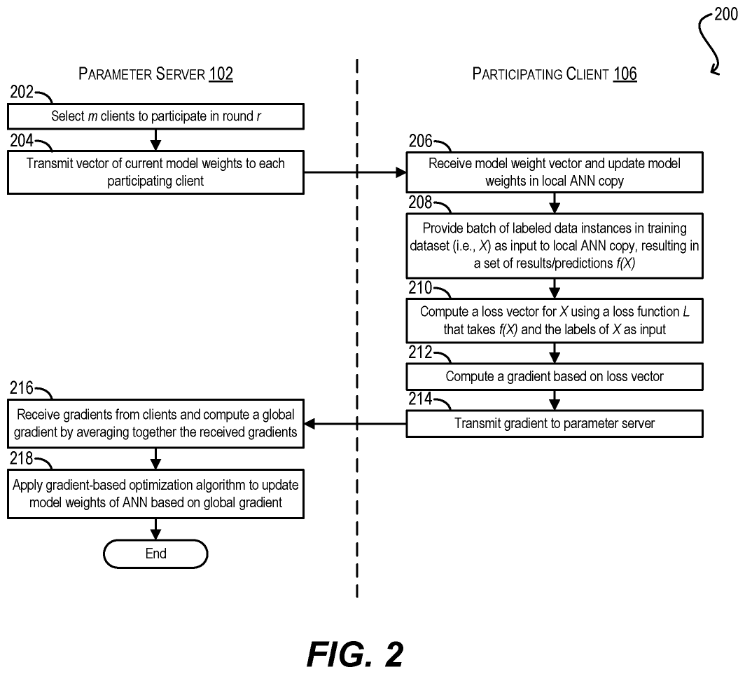

Embodiments of the present disclosure are directed to techniques for compressing model weights for distributed and federated learning. To provide context for these embodiments, FIG. 1 depicts an example DL/FL system 100 that includes a parameter server 102 holding an ANN 104 and a set of clients 106(1)-(n). Each client 106 maintains a training dataset 108 comprising a plurality of labeled data instances and a local copy of ANN 104 (i.e., local ANN copy 110). In addition, FIG. 2 depicts a workflow 200 that may be performed by parameter server 102 and clients 106(1)-(n) for training ANN 104 using a conventional DL/FL procedure.

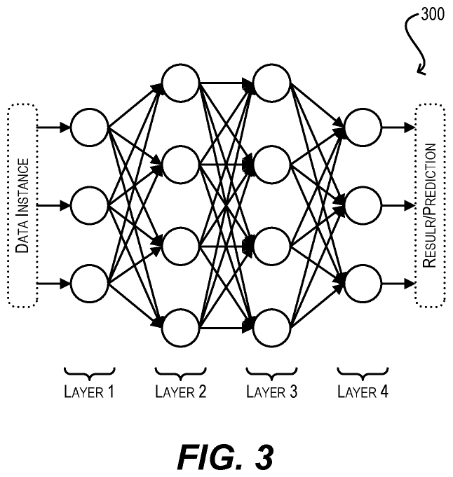

As known in the art, an ANN is a type of machine learning model that includes a collection of nodes which are organized into layers and are interconnected via directed edges. For example, FIG. 3 depicts a version of ANN 104 (reference numeral 300) that includes a total of fourteen nodes and four layers 1-4. The edges are associated with parameters (i.e., model weights, not shown) that control how a data instance, which is provided as input to the ANN via the first layer, is processed to generate a result/prediction, which is output by the last layer. These model weights are adjusted as part of the DL/FL procedure to optimize the ANN's performance in generating correct results/predictions.

Conventional DL/FL proceeds according to a series of rounds and workflow 200 of FIG. 2 illustrates the steps performed by DL/FL system 100 as part of a single round r. Starting with steps 202 and 204, parameter server 102 selects m out of the n clients to participate in round r and transmits a vector of the current model weights for ANN 104 (i.e., a model weight vector) to each of these participating clients.

At step 206, each participating client receives the model weight vector and updates the model weights in its local ANN copy 110 with the values in this vector. The client then performs a training pass on its local ANN copy 110 that involves (1) providing a batch of labeled data instances in its training dataset 108 (denoted as the matrix X) as input to local ANN copy 110, resulting in a set of results/predictions f (X) (step 208); (2) computing a loss vector for X using a loss function L that takes f (X) and the labels of X as input (step 210); and (3) computing, based on the loss vector, a vector of derivative values of L with respect to the model weights, referred to as a gradient (step 212). Generally speaking, this gradient indicates how much the output of local ANN copy 110 changes in response to changes to the ANN's model weights, in accordance with the loss vector. Upon completing this training pass, the client transmits the gradient to parameter server 102 (step 214).

At step 216, parameter server 102 receives the gradients from the participating clients of round r and computes a global gradient by averaging together the received gradients. Finally, at step 218, parameter server 102 applies a gradient-based optimization algorithm such as gradient descent to update the model weights of ANN 104 in accordance with the global gradient and the current round ends. Steps 202-218 can subsequently be repeated for additional rounds r+1, r+2, etc. until a termination criterion is reached that ends the DL/FL procedure. This termination criterion may be, e.g., a lower bound on the size of the global gradient, an accuracy threshold for ANN 104, or a number of rounds threshold.

As noted in the Background section, an issue with the conventional DL/FL procedure shown in FIG. 2 is that the sizes of the model weight vector sent by parameter server 102 at step 204 and the gradients sent by the participating clients at step 214 are proportional to the number of parameters in ANN 104, which can be in the billions. Thus, the network bandwidth needed between clients 106(1)-(n) and parameter server 102 to carry out the DL/FL procedure will often be very high, which is problematic in scenarios where the clients are subject to network connectivity/bandwidth constraints.

Existing approaches that attempt to solve this issue via data compression focus on compressing the gradients every round using a low encoding complexity/high encoding speed compression scheme like stochastic quantization or sparsification. Such a scheme, hereinafter referred to as a “low complexity” compression scheme, encodes (i.e., compresses) data relatively quickly at the cost of introducing higher approximation error. However, these existing approaches refrain from compressing the model weight vector in the same manner because there is no averaging effect to reduce the approximation error in the compressed model weight vector, and the norm of this vector does not decay to zero (unlike the gradients). Taken together, these factors make the approximation error arising out of compressing the model weight vector using a low complexity compression scheme too high to be practical.

An alternative approach is to compress the model weight vector every round using a high encoding complexity/low encoding speed compression scheme. Such a scheme, hereinafter referred to as a “high complexity” compression scheme, performs the encoding (i.e., compression) operation more slowly than low complexity schemes due to using a more sophisticated compression algorithm, but introduces significantly less approximation error in the compressed output. Unfortunately, this approach is too slow to be usable in most real-time DL/FL use cases/applications.

To address the foregoing, embodiments of the present disclosure provide a hybrid approach for compressing the model weights of an ANN in a DL/FL setting that leverages both low complexity and high complexity compression schemes. In particular, this hybrid approach employs a high complexity compression scheme to compress the ANN's model weights every k rounds of the DL/FL procedure, where k is a configurable number. Each k-th round is referred to as an anchor round and the compressed model weight vector created for an anchor round is referred to as an anchor point. Examples of high complexity compression schemes that can be used for this purpose include entropy constraint quantization and variants/approximations thereof.

The hybrid approach further employs a low complexity compression scheme to compress the accumulated differences in model weights of the ANN for each intermediate round between the anchor rounds. Examples of low complexity compression schemes that can be used for this purpose include DRIVE, EDEN, stochastic quantization, sparsification, kashin's representation, and so on. For instance, if round k was the last anchor round and round k+2 is the current round, the sum of the global gradients computed in rounds k and k+1 can be compressed using the low complexity compression scheme, and this compressed data (referred to as a correction) can sent with the anchor point from previous anchor round k to the participating clients of round k+2. Each participating client can then reconstruct the ANN's model weights for round k+2 by decompressing the anchor point and correction respectively and combining the decompressed data.

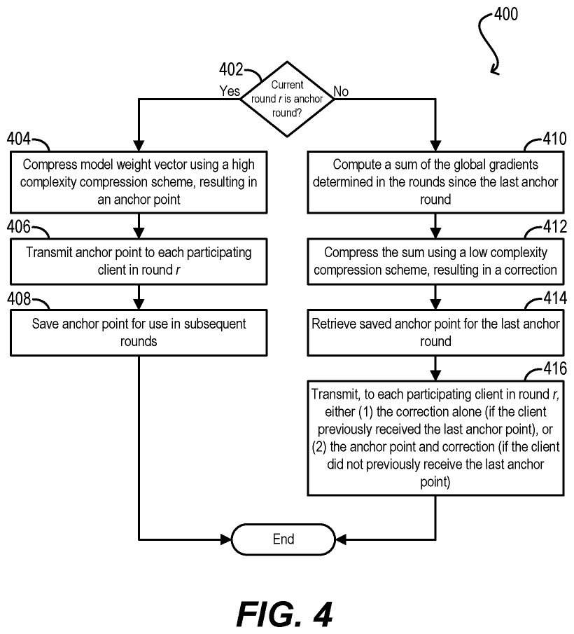

To clarify how this hybrid approach may work in certain embodiments, FIG. 4 depicts a high-level workflow 400 that may be performed by parameter server 102 of FIG. 1 for compressing and transmitting model weight information to the participating clients of a current round r using this approach. Parameter server 102 may perform workflow 400 as part of, e.g., step 204 of FIG. 2.

Starting with step 402 of workflow 400, parameter server 102 can check whether current round r is an anchor round (i.e., whether r is a multiple of k). If the answer is yes, parameter server 102 can compress a vector of the current model weights of ANN 104 using a high complexity compression scheme (step 404) and transmit this compressed model weight vector (which is an anchor point) to each participating client in round r (step 406). Parameter server 102 can then save the anchor point for future use in subsequent rounds (step 408).

However, if the answer at step 402 is no (i.e., current round r is not an anchor round), parameter server 102 can compute a sum of the global gradients determined for ANN 104 in the previous rounds since the last anchor round (step 410). For example, if the last anchor round was round 2k and current round is r=2k+3, parameter server 102 can compute the sum of the global gradients determined at the end of rounds 2k, 2k+1, and 2k+2. Parameter server 102 can thereafter compress the sum using a low complexity compression scheme (resulting in a correction) (step 412) and retrieve the saved anchor point for the last anchor round (step 414). Finally, parameter server 102 can transmit to each participating client in round r (1) the correction alone (if that client previously received the anchor point for the last anchor round), or (2) both the anchor point and the correction (if that client did not previously receive the anchor point) (step 416).

Although not shown in FIG. 4, once each participating client receives either an anchor point alone (as transmitted at step 406), both an anchor point and a correction, or a correction alone (as transmitted at step 416), the client can decode (i.e., decompress) the received data, update the model weights of its local ANN copy 110 based on the decompressed information, and proceed with executing a training pass of the ANN in accordance with step 208 and onward in FIG. 2. More specifically, if the client receives an anchor point, the client can decompress it using the decode operation of the high complexity compression scheme and can replace the model weights in its local ANN copy 110 with the model weights in the decompressed model weight vector.

Alternatively, if the client receives both an anchor point and a correction, the client can decompress the anchor point using the decode operation of the high complexity compression scheme and decompress the correction using the decode operation of the low complexity compression scheme. The client can then combine these decompressed components to compute a current set of model weights and replace the model weights in its local ANN copy 110 with the computed weights.

Alternatively, if the client receives a correction alone, the client can decompress the correction using the decode operation of the low complexity compression scheme. The client can then combine the correction with the anchor point previously received from parameter server 102, compute a current set of model weights based on that combination, and replace the model weights in its local ANN copy 110 with the computed weights.

With the hybrid approach described above, a number of benefits are achieved/possible. First, because the model weight information sent by parameter server 102 during each DL/FL round is compressed, a significant amount of network bandwidth is saved over the course of the DL/FL procedure. This makes DL/FL feasible in scenarios where the clients have spotty or limited network connectivity/bandwidth, such as cross-device federated learning scenarios. At the same time, the average time needed to perform the model weight compression is kept low and the approximation error in the compressed data is minimized, resulting in a “best of all worlds” outcome.

In particular, with respect to compression time, the high complexity (i.e., slow) compression scheme is applied only once every k rounds rather than every round. Thus, the encoding cost of this scheme is amortized across multiple rounds, resulting in relatively fast compression on average.

With respect to approximation error, a relatively high proportion of the model weight information (i.e., the model weights at the anchor rounds) is compressed using the high complexity compression scheme, while a lower proportion (i.e., the accumulated differences at the intermediate rounds) is compressed using the low complexity compression scheme. This means that the overall approximation error in the compressed model weight information will be dominated by the error introduced by the high complexity scheme, which is small. Further, because the accumulated differences for each intermediate round are computed as the sum of a series of global gradients, this sum will decay to zero as the DL/FL procedure progresses. Accordingly, the corrections for the intermediate rounds will also decay to zero, such that the approximation error in the model weights will come entirely from the anchor points towards the end of the DL/FL procedure (and thus, entirely from the small error introduced by the high complexity compression scheme).

Second, in certain embodiments the hybrid approach can be leveraged to increase the time window that a client has for receiving (i.e., downloading) model weight information from parameter server 102 for a future round t where the client will participate. This is generally achieved by transmitting, by the parameter server, an anchor point to the client in advance of round t (for example, at the time of a prior round t−i) and then transmitting the appropriate correction for round t to the client at the start t. This technique, which is particularly useful for cross-device FL (e.g., FL across a broadly distributed population of clients with varying levels of network connectivity/bandwidth), is discussed in further detail in section (2) below.

It should be appreciated that FIGS. 1-4 are illustrative and not intended to limit embodiments of the present disclosure. For example, although parameter server 102 is depicted as a singular server/computer system, in some embodiments parameter server 102 may be implemented as a cluster of servers/computer systems for enhanced performance, reliability, and/or other reasons. One of ordinary skill in the art will recognize other variations, modifications, and alternatives.

### 2. Increasing the Time Window for Downloading Model Weights

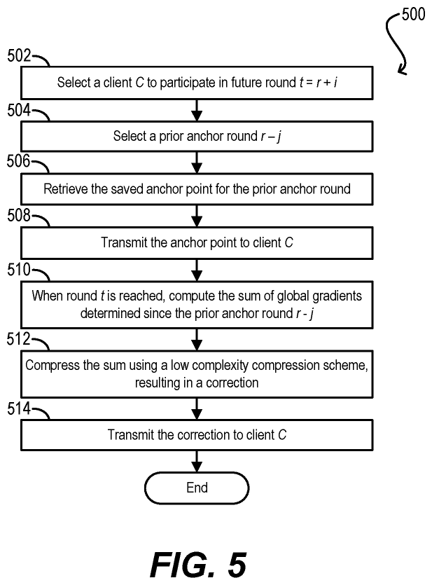

Workflow 300 of FIG. 3 assumes that parameter server 102 transmits compressed model weight information (in the form of an anchor point and/or correction) to the participating clients of a round r in a “just-in-time” manner at the start of r. However, some clients, such as mobile devices with slow/unstable network connectivity or clients in remote geographic regions, may not have sufficient network bandwidth to download the entirety of this data within the time constraints of a single round. To address this, FIG. 5 depicts a workflow 500 that may be performed by parameter server 102 for creating and sending an anchor point to a client in advance of the round in which that client will participate. This advantageously gives the client an expanded time window to download that anchor point data and thus enables the client to successfully participate in the DL/FL procedure, despite suffering from relatively slow network connectivity.

Starting with step 502, parameter server 102 can select a particular client C to participate in a future DL/FL round t=r+i where r is the current round.

At steps 504 and 506, parameter server 102 can select a prior anchor round r−j and can retrieve the saved anchor point for that prior anchor round. In most cases, this prior anchor round will be the more recent anchor round preceding current round r. In some embodiments, the prior anchor round may be current round r if r itself is an anchor round, in which case parameter server 102 can create an anchor point at step 506 by compressing the current model weights of ANN 104 using the high complexity compression scheme.

Parameter server 102 can then transmit the anchor point for the prior anchor round to client C (assuming a prior anchor point has not already been sent to C), thereby giving the client i rounds to download the entirety of that data (step 508).

When round t is reached, parameter server 102 can compute the sum of the global gradients determined since the prior anchor round r−j (or in other words, the sum of the global gradients computed at the end of rounds r−j, r−j+1, . . . , r+i−1) and can compress this sum using the low complexity compression scheme, resulting in a correction (steps 510 and 512). Finally, at step 514, parameter server 102 can transmit the correction to client C, thereby enabling the client to reconstruct the current model weights of ANN 104 using the model weights in the previously transmitted anchor point and the accumulated differences in the correction. Generally speaking, this correction will be substantially smaller in size than the anchor point, which allows client C to download it within the time constraints of a single round.

### 3. Other Enhancements

### 3.1 Adaptive Modification of k

In certain embodiments, rather than being a fixed value, the hyperparameter k can be adaptively modified by parameter server 102 as the DL/FL procedure progresses, either to improve the performance of the learning procedure or to manage the parameter server's load. For example, in one set of embodiments, parameter server 102 may choose to create a new anchor point (and thus define a new anchor round) whenever the norm of the sum of the global gradients since the last anchor round exceeds a threshold. This is useful because if the sum becomes too large, the approximation error arising out of compressing the sum via the low complexity compression scheme will also become large, which is undesirable.

It is also possible to keep the sum of global gradients since the last anchor round below a threshold by employing an aggressively low, fixed value for k. However, this approach is suboptimal because the global gradients will become smaller as the ANN converges, which means that it will take progressively longer to reach that threshold towards the tail end of the DL/FL procedure. Thus, it is preferable to adapt k as the procedure moves forward, which will avoid applying the high complexity compression scheme more often than needed.

In another set of embodiments, parameter server 102 can create a new anchor point whenever it has excess compute cycles to spare (for example, due to experiencing a slowdown in load with respect to other services/applications running on the server). As a corollary, parameter server 102 can also defer the creation of an anchor point if it detects a peak in computational load. In this way, parameter server 102 can dynamically increase or decrease the precision of the learning procedure based on its available resources.

### 3.2 Using Prior Anchor Points Beyond the Latest Anchor Round

As mentioned in section (2) above, in some embodiments parameter server 102 may transmit a prior anchor point to one or more clients in advance of the round in which the client(s) will need that information (i.e., a future round t), to provide a larger time window for downloading the anchor point data. That prior anchor point may be from the immediately previous anchor round or from an older anchor round. This means that for any given round r, the clients participating in r may be operating using different anchor points and thus may require different corrections from parameter server 102 in order to correctly reconstruct the current model weights of ANN 104.

Further, in certain cases parameter server 102 may take multiple rounds to create the anchor point for the latest anchor round. In these cases, parameter server 102 can continue sending to clients the anchor point from the prior anchor round (i.e., the one before the latest anchor round), along with appropriate corrections with respect to that prior anchor point, until it has created the latest anchor point. This concept is similar to the notion of deferring anchor point creation in response to high computational load discussed in subsection (3.1).

### 3.3 Dynamically Changing Bandwidth Allocation for Anchor Points and Corrections

Some clients, such as mobile devices on a cellular network connection, may impose a fixed bandwidth cap on the amount of data they can download over the course of the DL/FL procedure. For these types of clients, parameter server 102 may intelligently adjust the amount of bandwidth used to transmit the anchor points and corrections respectively as the DL/FL procedure progresses in order to ensure the clients stay below their caps, while also minimizing approximation errors.

For example, in certain embodiments parameter server 102 may start out the DL/FL procedure by allocating a moderate amount of bandwidth for transmitting the corrections (e.g., 30% of the total) by employing a moderate compression level via the low complexity compression scheme. Then, in later rounds, parameter server 102 may progressively reduce the amount of bandwidth used for the corrections (and conversely increase the amount of bandwidth used for the anchor points) by increasing the compression level of the low complexity compression scheme, because in those later rounds the sum of the global gradients will approach zero. In some embodiments, parameter server 102 may also take into account the bandwidth constraints of the clients when adaptively modifying k as discussed in subsection (3.1) above (because the value of k indirectly affects the total bandwidth needed for the DL/FL procedure).

### 3.4 Adding a Regularization Term to the Loss Function

As explained with respect to workflow 200 of FIG. 2, as part of performing a training pass on its local ANN copy 110, each client 106 computes a loss vector for the training data instances provided as input to the ANN using a loss function L that is designed to minimize the differences between the data instance labels and the predictions output by the ANN. The client then uses the loss vector to compute a gradient for L with respect to the ANN's model weights, which is sent to parameter server 102 to generate the global gradient and update the model weights via a gradient-based optimization algorithm.

In certain embodiments, an additional term (referred to as a regularization term) can be added to loss function L that attempts to minimize the differences between the current model weights and the compressed model weights from the last anchor point. This encourages the optimization algorithm to converge towards a set of model weights that minimizes the approximation error arising out of compressing the model weights using the high complexity compression scheme (i.e., creating a new anchor point), in addition to also optimizing the ANN to perform its prediction task.

For example, in a particular embodiment the regularization term can be defined as ∥W(t)− [symbol] ∥₂², where W(t) represents the current model weights of ANN 104, [symbol] represents the last anchor point, and λ is a scaling factor. Generally speaking, the addition of this regularization term to loss function L should not significantly affect the accuracy of the resulting trained ANN, as long as the ANN is over-parameterized (which is currently the standard regime for deep learning models). The influence of the regularization term on the overall learning process can also be controlled via appropriate configuration of scaling factor λ.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
determining, by a parameter server directing a distributed learning (DL) or federated learning (FL) procedure for training an artificial neural network (ANN), whether a current round of the DL or FL procedure is an anchor round; and
upon determining that the current round is an anchor round:
compressing, by the parameter server, a model weight vector comprising current model weights of the ANN using a first compression scheme, the compressing resulting in an anchor point;
transmitting, by the parameter server, the anchor point to each of a plurality of participating clients in the current round; and
saving, by the parameter server, the anchor point for use in subsequent rounds.

2. The method of claim 1 further comprising, upon determining that the current round is not an anchor round:
computing a sum of global gradients determined in one or more rounds since the last anchor round;
compressing the sum using a second compression scheme that has lower encoding complexity than the first compression scheme, the compressing of the sum resulting in a correction; and
retrieving a saved anchor point for a prior anchor round; and
for each participating client in the current round:
transmitting the correction to the participating client upon determining that the participating client has already received the saved anchor point; and
transmitting the retrieved anchor point and the correction to the participating client upon determining that the participating client has not already received the saved anchor point.

3. The method of claim 2 wherein the parameter server assigns a bandwidth allocation for transmitting anchor points and corrections, and wherein the bandwidth allocation is dynamically changed as the DL or FL procedure progresses.

4. The method of claim 1 wherein the current round is an anchor round if a round number of the current round is a multiple of a value k.

5. The method of claim 4 wherein the value k is adaptively modified by the parameter server as the DL or FL procedure progresses, based on a status of the DL or FL procedure or a resource load on the parameter server.

6. The method of claim 1 further comprising:
selecting a client to participate in a future round of the DL or FL procedure;
retrieving a saved anchor point for a prior anchor round;
transmitting the retrieved anchor point to the client before the future round; and
upon reaching the future round:
computing a sum of global gradients determined in one or more rounds since the prior anchor round;
compressing the sum using a second compression scheme that has lower encoding complexity than the first compression scheme, the compressing of the sum resulting in a correction; and
transmitting the correction to the client.

7. The method of claim 1 wherein a regularization term is added to a loss function used by the participating clients to generate a gradient for the ANN, the regularization term being designed to minimize differences between model weights of the ANN and the compressed model weights in the anchor point.

8. A non-transitory computer readable storage medium having stored thereon program code executable by a parameter server directing a distributed learning (DL) or federated learning (FL) procedure for training an artificial neural network (ANN), the program code causing the parameter server to:
determine whether a current round of the DL or FL procedure is an anchor round; and
upon determining that the current round is an anchor round:
compress a model weight vector comprising current model weights of the ANN using a first compression scheme, the compressing resulting in an anchor point;
transmit the anchor point to each of a plurality of participating clients in the current round; and
save the anchor point for use in subsequent rounds.

9. The non-transitory computer readable storage medium of claim 8 wherein the program code further causes the parameter server to, upon determining that the current round is not an anchor round:
compute a sum of global gradients determined in one or more rounds since the last anchor round;
compress the sum using a second compression scheme that has lower encoding complexity than the first compression scheme, the compressing of the sum resulting in a correction;
retrieve a saved anchor point for a prior anchor round; and
for each participating client in the current round:
transmit the correction to the participating client upon determining that the participating client has already received the saved anchor point; and
transmit the retrieved anchor point and the correction to the participating client upon determining that the participating client has not already received the saved anchor point.

10. The non-transitory computer readable storage medium of claim 9 wherein the parameter server assigns a bandwidth allocation for transmitting anchor points and corrections, and wherein the bandwidth allocation is dynamically changed as the DL or FL procedure progresses.

11. The non-transitory computer readable storage medium of claim 8 wherein the current round is an anchor round if a round number of the current round is a multiple of a value k.

12. The non-transitory computer readable storage medium of claim 11 wherein the value k is adaptively modified by the parameter server as the DL or FL procedure progresses, based on a status of the DL or FL procedure or a resource load on the parameter server.

13. The non-transitory computer readable storage medium of claim 8 wherein the program code further causes the parameter server to:
select a client to participate in a future round of the DL or FL procedure;
retrieve a saved anchor point for a prior anchor round;
transmit the retrieved anchor point to the client before the future round; and
upon reaching the future round:
compute a sum of global gradients determined in one or more rounds since the prior anchor round;
compress the sum using a second compression scheme that has lower encoding complexity than the first compression scheme, the compressing of the sum resulting in a correction; and
transmit the correction to the client.

14. The non-transitory computer readable storage medium of claim 8 wherein a regularization term is added to a loss function used by the participating clients to generate a gradient for the ANN, the regularization term being designed to minimize differences between model weights of the ANN and the compressed model weights in the anchor point.

15. A computer system involved in directing a distributed learning (DL) or federated learning (FL) procedure for training an artificial neural network (ANN), the computer system comprising:
a processor; and
a non-transitory computer readable medium having stored thereon program code that, when executed by the processor, causes the processor to:
determine whether a current round of the DL or FL procedure is an anchor round; and
upon determining that the current round is an anchor round:
compress a model weight vector comprising current model weights of the ANN using a first compression scheme, the compressing resulting in an anchor point;
transmit the anchor point to each of a plurality of participating clients in the current round; and
save the anchor point for use in subsequent rounds.

16. The computer system of claim 15 wherein the program code further causes the processor to, upon determining that the current round is not an anchor round:
compute a sum of global gradients determined in one or more rounds since the last anchor round;
compress the sum using a second compression scheme that has lower encoding complexity than the first compression scheme, the compressing of the sum resulting in a correction;
retrieve a saved anchor point for a prior anchor round; and
for each participating client in the current round:
transmit the correction to the participating client upon determining that the participating client has already received the saved anchor point; and
transmit the retrieved anchor point and the correction to the participating client upon determining that the participating client has not already received the saved anchor point.

17. The computer system of claim 16 wherein the processor assigns a bandwidth allocation for transmitting anchor points and corrections, and wherein the bandwidth allocation is dynamically changed as the DL or FL procedure progresses.

18. The computer system of claim 15 wherein the current round is an anchor round if a round number of the current round is a multiple of a value k.

19. The computer system of claim 18 wherein the value k is adaptively modified by the processor as the DL or FL procedure progresses, based on a status of the DL or FL procedure or a resource load on the computer system.

20. The computer system of claim 15 wherein the program code further causes the processor to:
select a client to participate in a future round of the DL or FL procedure;
retrieve a saved anchor point for a prior anchor round;
transmit the retrieved anchor point to the client before the future round; and
upon reaching the future round:
compute a sum of global gradients determined in one or more rounds since the prior anchor round;
compress the sum using a second compression scheme that has lower encoding complexity than the first compression scheme, the compressing of the sum resulting in a correction; and
transmit the correction to the client.

21. The computer system of claim 15 wherein a regularization term is added to a loss function used by the participating clients to generate a gradient for the ANN, the regularization term being designed to minimize differences between model weights of the ANN and the compressed model weights in the anchor point.
